(19) United States
(12) Patent Application Publication
(10) Pub. No.: US 2026/0003746 A1
(43) Pub. Date: Jan. 1, 2026

(54) FAULT IDENTIFICATION AND RECOVERY FOR DISTRIBUTED TRAINING

(71) Applicant: Lemon Inc., Grand Cayman (KY)

(72) Inventors: Ziheng JIANG, Los Angeles, CA (US); Haibin LIN, Los Angeles, CA (US); Xin LIU, Los Angeles, CA (US); Yanghua PENG, Los Angeles, CA (US)

(21) Appl. No.: 18/758,347

(22) Filed: Jun. 28, 2024

(51) Int. Cl. G06F 11/20; G06F 11/27; H04L 47/11; H04L 67/10

(52) U.S. Cl. CPC G06F 11/20; G06F 11/27; H04L 47/11; H04L 67/10; G06F 2201/85

(57) ABSTRACT

Example embodiments of the present disclosure relate to a method, a device and a non-transitory computer-readable medium for distributed training. The method comprises obtaining, during a distributed training task performed across a plurality of computing nodes, at least one heartbeat message from the plurality of computing nodes, each computing node including multiple GPU workers; detecting, based on the at least one heartbeat message, an abnormal status of the distributed training task; commanding the plurality of computing nodes to run at least one self-check diagnostics test; identifying, based on results of the at least one self-check diagnostics test, at least one faulty node from the plurality of computing nodes; and replacing the at least one faulty node with an equivalent number of heathy computing nodes that have passed the at least one self-check diagnostics test.

### FIELD

Example embodiments of the present disclosure generally relate to the field of computers, and in particular, to a method, a device and a non-transitory computer-readable medium for fault identification and recovery for distributed training.

### BACKGROUND

Large language models (LLMs) have emerged as a transformative technology in artificial intelligence (AI). Recent advancements in LLMs have significantly improved their capability. LLMs have demonstrated tremendous potential in a wide range of domains, such as machine translation, text summarization, and conversational agents.

Training LLMs is a daunting task that requires enormous computation resources. The model size and the training data size are critical factors that determine the model capability. To achieve state-of-the-art model capability, many efforts have been devoted to train large models with hundreds of billions or even trillions of parameters on hundreds of billions or even trillions of tokens. Typically, distributed training is widely utilized for LLMs where the training process is divided among multiple computing devices, such as GPUs, instead of being executed on a single machine. This approach enables the handling of larger datasets and more complex models by parallelizing the computation across multiple devices. However, scaling training to tens of thousands of GPUs brings unprecedented challenges.

### SUMMARY

Example embodiments of the present disclosure relates to solutions for fault identification and recovery for distributed training.

In a first aspect, there is provided a method. The method comprises: obtaining, during a distributed training task performed across a plurality of computing nodes, at least one heartbeat message from the plurality of computing nodes, each computing node including multiple graphic processing unit (GPU) workers; detecting, based on the at least one heartbeat message, an abnormal status of the distributed training task; commanding the plurality of computing nodes to run at least one self-check diagnostics test; identifying, based on results of the at least one self-check diagnostics test, at least one faulty node from the plurality of computing nodes; and replacing the at least one faulty node with an equivalent number of heathy computing nodes that have passed the at least one self-check diagnostics test.

In a second aspect, there is provided a device comprising: at least one processor; and at least one memory storing instructions that, when executed by the at least one processor, cause the device at least to: obtain, during a distributed training task performed across a plurality of computing nodes, at least one heartbeat message from the plurality of computing nodes, each computing node including multiple graphic processing unit (GPU) workers; detect, based on the at least one heartbeat message, an abnormal status of the distributed training task; command the plurality of computing nodes to run at least one self-check diagnostics test; identify, based on results of the at least one self-check diagnostics test, at least one faulty node from the plurality of computing nodes; and replace the at least one faulty node with an equivalent number of heathy computing nodes that have passed the at least one self-check diagnostics test.

In a third aspect, there is provided non-transitory computer-readable storage medium comprising executable instructions stored therein that, in response to execution by a processor of a device, cause the device to at least: obtain, during a distributed training task performed across a plurality of computing nodes, at least one heartbeat message from the plurality of computing nodes, each computing node including multiple graphic processing unit (GPU) workers; detect, based on the at least one heartbeat message, an abnormal status of the distributed training task; command the plurality of computing nodes to run at least one self-check diagnostics test; identify, based on results of the at least one self-check diagnostics test, at least one faulty node from the plurality of computing nodes; and replace the at least one faulty node with an equivalent number of heathy computing nodes that have passed the at least one self-check diagnostics test.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific embodiment described herein. This disclosure is intended to be read holistically such that any separable features or elements of the disclosure, in any of its aspects and embodiments, should be viewed as combinable unless the context of the disclosure clearly dictates otherwise.

It will therefore be appreciated that Summary is provided merely for purposes of summarizing some embodiments so as to provide a basic understanding of some aspects of the disclosure. Accordingly, it will be appreciated that the above described embodiments are merely examples and should not be construed to narrow the scope or spirit of the disclosure in any way. Other embodiments, aspects and advantages will become apparent from the following detailed description taken in conjunction with the accompanying figures which illustrate, by way of example, the principles of some described embodiments.

### BRIEF DESCRIPTION OF THE DRAWINGS

Some example embodiments will now be described with reference to the accompanying drawings, in which:

FIG. 1 illustrates an example environment in which example embodiments of the present disclosure may be implemented;

FIG. 2 illustrates an example of data parallel training according to some example embodiments of the present disclosure;

FIG. 3 illustrates an example of pipeline parallel training according to some example embodiments of the present disclosure;

FIG. 4 illustrates overlapping communication in tensor parallelism (TP) and sequence parallelism (SP) with parallel transformer block (PTB) according to some example embodiments of the present disclosure;

FIG. 5 illustrates overlapping communication in pipeline parallelism according to some example embodiments of the present disclosure;

FIG. 6 illustrates a robust training workflow according to some example embodiments of the present disclosure;

FIG. 7A illustrates a performance heat-map according to some example embodiments of the present disclosure;

FIG. 7B illustrates an event timeline on machines in a trace format according to some example embodiments of the present disclosure;

FIG. 8 illustrates an example flowchart of a method implemented according to example embodiments of the present disclosure;

FIG. 9 illustrates a block diagram of an example of a computing device suitable for implementing example embodiments of the present disclosure.

Throughout the drawings, the same or similar reference numerals represent the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained iteratively using a great amount of training data until the model can obtain, from the training data, consistent inference similar to those that human intelligence can make. Through the training, the machine learning model may be regarded as being capable of learning the association between the input and the output (also referred to an input-output mapping) from the training data. The set of parameter values of the trained model is determined. At the validation stage, a validation input is applied to the trained machine learning model to test whether the model can provide a correct output, so as to determine the performance of the model. At the application stage, the resulting machine learning model may be used to process an actual model input based on the set of parameter values obtained from the training and to determine the corresponding model output.

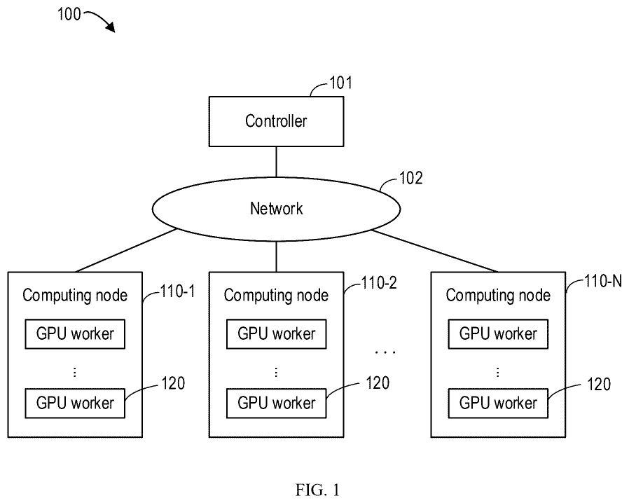

FIG. 1 illustrates an example environment in which example embodiments of the present disclosure may be implemented. The environment 100 may be implemented as a cluster 100. As shown, the cluster 100 comprises a group computing nodes 110-1, 110-2 . . . 110-N (collectively 110) connected via network 102. The computing nodes 130 may work together as a single system to perform computational tasks, for example, a distributed training task. Each computing node 130 may be equipped with one or more processors such as graphic processing units, memory, storage, and networking capabilities. For training machine learning models, the computing node may include multiple GPU workers 120, which are able to handle large-scale data processing, parallel processing, and other computationally intensive tasks. In some implementation, the cluster 100 may comprise a massive number of GPUs (e.g., more than 10,000) for large language model (LLM) training.

The cluster 100 may further include a controller 101 responsible for orchestrating and managing the parallel execution of tasks across computing nodes 110. This controller 101 coordinates the distribution of computational workload, monitors the progress of tasks, and ensures efficient utilization of cluster resources. The controller 101 may also handle task scheduling, data distribution, fault tolerance, and load balancing to optimize performance and reliability. The controller 101 may be implemented as an electronic device equipped with one or more processors such as central processing units CPUs, memory, storage, and networking capabilities.

For distributed training task, the controller 101 may divides the training data into smaller batches or shards and distributes them among the computing nodes 110 and the GPU workers 120. Each GPU worker 120 obtains its local replica and independently processes its assigned data to update the local model. The GPU workers 120 compute gradients based on their local data. The controller 101 may aggregates these gradients and updates the global model parameters. This synchronization ensures that all workers are working towards a consistent model. During the training process, model parameters and gradients are transferred over the network 101 (inter-node communication) and within the computing nodes 130 (intra-node/host communication). In some embodiments, the controller 101 may monitor the progress of the training process, including metrics like loss function values, accuracy, and convergence. It may also coordinate other aspects, such as checkpointing, logging, and handling failures or stragglers.

In the following, embodiments of the disclosure will be described mainly with respect to distributed large language model (LLM) training. It would be understood that different models other than LLMs are also applicable.

In some implementation, the cluster 100 may comprise more than 10,000 GPUs for large language model (LLM) training. However, scaling LLM training to tens of thousands of GPUs brings unprecedented challenges. The first challenge is to achieve high training efficiency at scale. Model FLOPs utilization (MFU) is the ratio of the observed throughput to the theoretical maximum throughput assuming 100% of peak FLOPs. It is a standard metric to evaluate training efficiency that directly translates to end-to-end training speed. LLM training is not embarrassingly parallel. To train an LLM, the model is split across GPUs and the GPUs heavily communicate with each other to make progress. Besides communication, other factors such as operator optimization, data preprocessing and GPU memory consumption also contribute significantly to MFU.

The second challenge is to achieve high training stability at scale, i.e., maintaining high training efficiency throughout the training process. Stability is particularly important from a production perspective, as LLMs take a long time to train. Training an LLM with one trillion tokens can take weeks. The scale and time are orders of magnitude larger than those of regular deep neural network (DNN) training jobs. Failures and stragglers are the norm rather than the exception for LLM training. At such a scale, the consequences of failures and stragglers are devastating. Failures are very expensive, and it is critical to reduce the recovery time, given the large scale. A straggler not only affects its own work, but slows down the entire job involving tens of thousands of GPUs

In this disclosure, solutions are provided to scale distributed training to massive number of GPUs (e.g., more than tens of thousands GPUs). The solutions are able to harness the power of the massive number of GPUs to train LLMs with high training efficiency and stability.

### Parallelism Strategies

The training of LLMs, characterized by their vast model architectures and massive datasets, is computationally intensive. Parallelism strategies distribute the training process across multiple devices, including data parallelism, pipeline parallelism, tensor parallelism, and combination thereof.

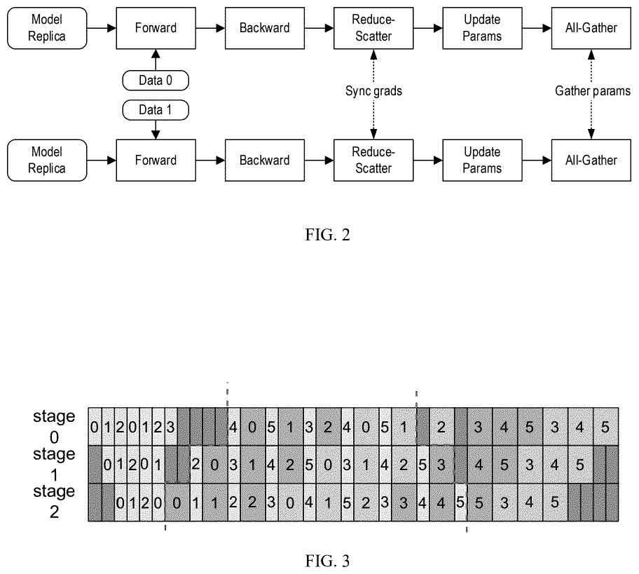

FIG. 2 illustrates an example of data parallel training according to some example embodiments of the present disclosure. The data parallelism replicates the model and optimizer states across multiple devices and the data is evenly divided among all devices. Each model replica executes the forward and backward propagation computation in parallel. Upon completion of each iteration, all model replicas synchronize to update the model. Instead of duplicating model states (like the optimizer states, gradients, and parameters), these states may be sharded across every data-parallel process. As a result, the all-reduce operations that aggregate gradients are decomposed into separate reduce-scatter and all-gather operations. This is because every data-parallel process retains only a fraction of the total state. The training process may be structured into three incremental stages of optimizations. Notably, the second stage is commonly adopted to shard both the optimizer states and gradients, while ensuring no additional communication overhead is introduced.

FIG. 3 illustrates an example of pipeline parallel training according to some example embodiments of the present disclosure. FIG. 3 shows a warm-up phase, a steady phase and a cool-down phase over time. The pipeline parallelism distributes model layers among multiple devices and each device owns a portion of the model. Meanwhile, each training batch is subdivided into a number of micro-batches for pipelined execution. Each pipeline stage on every worker may be subdivided into multiple virtual stages, which represents a subset of layers, referred to as a model chunk. Initially, workers enter a warm-up phase, executing the forward pass for a limited number of in-flight micro-batches. Following the warm-up, each worker progresses to the steady phase where workers perform one forward pass followed by one backward pass, often abbreviated as 1F1B. Upon concluding a batch, workers finalize the backward passes for any remaining in-flight micro-batches during this cool-down phase. FIG. 3 shows a three-stage pipeline where each stage is further divided into two virtual stages.

The tensor parallelism distributes individual operators over multiple devices, with each device executing a portion of the computation in parallel. Depending on the specific partitioning strategy and its relationship to prior and subsequent operators in the model, partitioning can require communication among participating GPUs to split the input and then merge the output. For example, general matrix multiplies (GEMMs) in the MLP and self-attention blocks may be split among multiple GPUs to utilize more computational units. Some other operations like LayerNorm and Dropout are less computationally intensive but demand a considerable amount of activation memory. Another form of tensor parallelism called sequence parallelism is proposed to distribute these operators along the sequence dimension to effectively reduce the activation memory footprint.

These parallelism strategies may be combined into 3D parallelism to scale the training of LLMs across many GPUs. Given the high communication overhead associated with tensor parallelism, it is preferable to confine such communication within a single cluster node. Conversely, data parallelism and pipeline parallelism are more amenable to inter-node communication. In this case, it is proposed to prioritize building the data parallelism groups over pipeline parallelism, which can mitigate cross-minipod communication for data parallelism.

### Efficient Training at Scale

The following approaches are provided for efficient training at scale. In some embodiments, a parallel version of the transformer block in lieu of the standard serialized formulation. Specifically, the standard formula of the transformer block can be reformatted from

$$y = x + MLP ( LN ( x + Attention ( LN ( x ) ) ) ) \qquad ( 1 )$$

$$into$$

$$y = x + MLP ( LN ( x ) ) + Attention ( LN ( x ) ) \qquad ( 2 )$$

With this approach, the computation of the attention block and the MLP block can be executed in parallel, thereby reducing the computation time.

Sliding window attention (SWA) is a sparse attention mechanism that employs a fixed size window surrounding each token in the input sequence. The computation complexity is O(s×w), where s is the input sequence length and w is the fixed window size. Sliding window attention is more efficient than the full self-attention, whose computation complexity is O(s×s), given that w<<s. In this way, the information across the entire input can be retained with a large receptive field created by stacking layers of such windowed attention. This enables faster training without compromising the accuracy.

To reduce the iteration time, the dependencies between computation and communication for all the operators in 3D parallelism is analyzed and the following techniques are designed to hide the overhead of all the off-the-critical-path operations.

With regard to overlapping in data parallelism, as shown in FIG. 2, for data parallelism, two main communication operations stand out. One is the all-gather operation, which fetches the most recent model parameters from workers in other data parallel ranks during the forward pass. The other is the reduce-scatter operation, which collect the gradients in the backward pass. In 3D parallelism, a single device may host multiple model chunks. Overlapping is implemented on a model chunk basis to maximize bandwidth utilization. The all-gather operation is triggered prior to the forward pass of a model chunk, and the reduce-scatter operation commences after its backward pass. This results in a challenge where the first all-gather operation and the last reduce-scatter operation cannot be hidden. In some embodiments, the initial all-gather operation is pre-fetched at the beginning of each iteration, allowing it to overlap with data loading operations, effectively reducing the communication time by a factor of 1/(2*vpp_size). The high priority communication may be launched first to maximize overlapping. The priorities of communication operators are determined by the order of the corresponding computation operators that depend on the communication result.

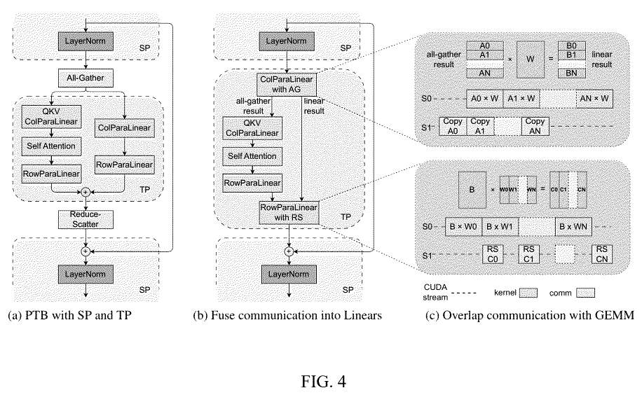

FIG. 4 illustrates overlapping communication in tensor parallelism (TP) and sequence parallelism (SP) with parallel transformer block (PTB) according to some example embodiments of the present disclosure. Tensor parallelism may be used to partition weights in computational-intensive operations, while operations like LayerNorm and Dropout are partitioned along the sequence dimension to save GPU memory. This necessitates all-gather and reduce-scatter operations for input collection and output redistribution across GPUs. FIG. 4(a) shows this communication pattern in the parallel transformer block architecture. Here the two communication operators are in the critical path. To eliminate this overhead, choose to fuse all-gather and reduce-scatter with the parallel Linears on the FFN path, as shown in FIG. 4(b). Since the GEMM kernels on the FFN path is larger, the communication can be hidden better, it proposed to break the GEMM kernel into small chunks, and pipeline the execution with the communication, as shown in FIG. 3(c). This strategy can be applied in the backward pass similarly.

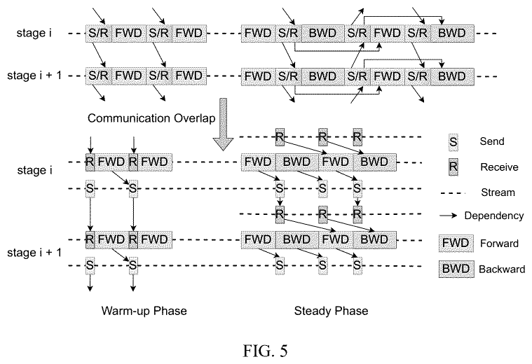

FIG. 5 illustrates overlapping communication in pipeline parallelism according to some example embodiments of the present disclosure. Pipeline parallelism features point-to-point send/receive communication. The proposed training may use the interleaved 1F1B scheduling method mentioned in FIG. 3. In the warm-up phase, the forward pass only depends on its previous receive. Thus, the send and receive operations may be decoupled, which are often implemented together and can be blocked by the slower one. By breaking this dependency, the send operation can overlap with the computation as shown in the left part of FIG. 5. The cool-down phase can be viewed as the inverse of the warm-up phase, allowing for the inverse application of the same technique. As for the steady phase, both the forward and backward computation are independent of adjacent communication operations. Taking the backward as an example, as shown in the right part of FIG. 5, its previous receive is for the next forward computation while the send is for the backward computation in the previous stage. So the send and receive operations can be launched asynchronously to overlap with the computation.

Data preprocessing and loading are often overlooked. However, these operations create non-negligible GPU idle time at the beginning of each training step. Optimizing these operations are essential for efficiency of the training process.

Asynchronous data preprocessing is proposed. While the GPU workers are synchronizing gradients at the end of each training step, the data preprocessing for the subsequent step can start, which hides the preprocessing overhead.

Redundant dataloader elimination is also proposed. In a typical data loading phase of distributed training, each GPU worker is equipped with its own data loader, responsible for reading training data into the CPU memory before forwarding it to the GPU. This leads to competition among workers for disk read bandwidth, thereby creating a bottleneck. It is observed that in the LLM training setting, GPU workers within the same machine are in the same tensor parallel group. Consequently, their inputs for each iteration are inherently identical. Based on this observation, a two-layer tree-based approach may adopted: a single, dedicated data loader on each machine is used to read the training data into a piece of shared memory; subsequently, each GPU worker is responsible for copying the necessary data to its own GPU memory. This eliminates redundant reads and significantly enhances the efficiency of data transfer.

### Fault Tolerance

As the training cluster scales to a large number of GPUs, software and hardware faults become virtually inevitable. A robust training framework is proposed for the distributed training that achieves automatic fault identification and fast recovery, enabling fault tolerance with minimal human intervention and negligible impact on ongoing training tasks.

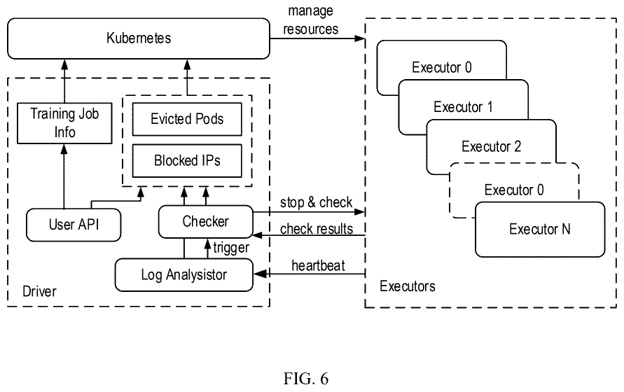

FIG. 6 illustrates a robust training workflow according to some example embodiments of the present disclosure. As FIG. 6 shows, upon receiving a submitted training task, the driver process interfaces with a custom Kubernetes to allocate computing resources and initiate the corresponding Pod for each executor. One executor manage one node. Once the executor has completed a series of initialization tasks, it creates the training process on each GPU and a robust training daemon which sends heartbeat to the driver periodically. These heartbeats encapsulate various forms of information to enable real-time anomaly detection and issue early warnings. When the driver process detects an abnormal status in a particular training process, or fails to receive a heartbeat from an executor within a predefined time window, it triggers the fault recovery procedure. The driver will suspend the ongoing training task across all executors and command them to run a series of self-check diagnostics. These diagnostic tests are carefully designed to be lightweight yet comprehensive, covering the majority of common hardware and software faults. Once the problematic nodes are identified, the driver submits the IP addresses of the nodes to be blocked, along with the information of the Pods running on them, to Kubernetes, which evicts the faulty nodes and replenishes the cluster with an equivalent amount of healthy ones which pass the diagnostic tests. Additionally, a user interface is provided, which allows for manual eviction of nodes, particularly for those identified through manual analysis as the next section (Training Troubleshooting). After the recovery process is complete, the driver resumes training from the latest checkpoint. The checkpoint and resume process is optimized to minimize the loss of training progress.

For data collection and analysis, the heartbeat messages may include the basic information of the executor, such as the IP address, the Pod name, and hardware information, etc. Additionally, the current status of the training processes is reported, enabling the driver to promptly detect any explicit anomalies. The output and error logs (e.g., stdout/stderr logs) of training processes may also be included. The heartbeat messages may be aggregated, filtered and analyzed on the fly. If specific warning or error keywords are detected, the driver may report real-time diagnostic information. Moreover, one or more Remote Direct Memory Access (RDMA) traffic metrics are also included, serving as an indicator for network utilization and efficiency. Some anomalies in the training process may not manifest as explicit errors, giving the appearance that training is proceeding as expected. In such cases, RDMA traffic metrics may serve as a critical indicator. Given the periodic nature of the training tasks, the network traffic characteristics for each step should exhibit similar patterns. Therefore, any significant decline or abnormal fluctuation in RDMA traffic is a signal of potential anomalies. Upon detecting such irregularities, the driver will issue alerts for manual investigation. If the traffic ceases entirely, the driver will automatically initiate the fault recovery procedure.

In order to enhance the monitoring of training stability and performance, a monitoring system with precision reaching the millisecond level is developed. Different levels of monitoring are employed to track various indicators. Second level monitoring is typically used to assess the overall health status and to rule out common configuration impacts on training. For instance, Explicit Congestion Notification (ECN), Priority-based Flow Control (PFC), and/or Quality of Service (QOS) configurations, link flapping, or any other issues of Network Interface Cards (NICs). Millisecond-level monitoring, on the other hand, is used to determine if the network is congested and whether the data transfer speed of data parallelism and pipe parallelism has reached its physical limit.

There exists a trade-off between execution time and accuracy in self-check diagnostics. Extended diagnostic duration can adversely affect the effective training time, while high false positive rates can lead to unnecessary exclusion of machines that are actually functional. A suite of lightweight diagnostic tests that effectively cover a broad spectrum of hardware and software faults encountered during actual training processes are provided as below.

The diagnostic tests may include an intra-host network test and a collective communications library test. The intra-host network test is used to diagnose potential bottlenecks in intra-host network. The intra-host network test may test two things. A Loopback test may measure the loopback bandwidth from all RDMA NICs (RNICs) to various intra-host endpoints, including memory nodes and GPUs. It conducts a full-mesh test within the host, covering all possible link combinations. This allows us to infer link-specific bandwidth degradation and irregularities in PCIe configurations based on end-to-end bandwidth results. The second RNICto-RNIC test examines the connectivity and bandwidth performance between different RNICs on the same host. These tests provide insights into whether the RNICs meet the hardware speed specifications and whether the underlying routing configurations are correctly configured.

The collective communications library test (e.g., NCCL test) is used to identify potential faults in GPU communication, the an all-to-all test may be run among the GPUs within a single node to observe whether the bandwidth aligns with expected benchmarks. Once intra-host communication test is passed, each node also conducts an all-reduce test with neighboring machines under the same top-of-rack (ToR) switch to assess inter-node GPU communication.

After identifying and evicting faulty machines, the driver needs to resume the training by loading model weights and optimizer states from the most recent checkpoint. It is critical to ensure that the latest checkpoint is as close as possible to the state of training progress when the faults happened, to minimize loss in computation and time. This requires increasing the frequency of checkpointing during training. However, reducing the latency introduced by the checkpointing process is also desirable, especially the time on the critical path which blocks the training progress, thus impeding the overall system throughput.

To achieve fast checkpointing, an optimized two-stage approach is provided. In the first stage, each GPU worker writes its on-chip states to the host memory, and then continues the training process. After the optimization of serialization mechanism and the use of pinned memory, this process can be reduced to several seconds thanks to the high PCIe bandwidth, thereby minimally interrupting the ongoing training process. In the second stage, a background process takes over, asynchronously transferring the state from the host memory to a distributed file system (HDFS in our deployment) for centralized maintenance. This decoupling of operations into two stages allows the GPU workers to resume training almost immediately after dumping their state, while the more time-consuming process of writing to HDFS is offloaded to a separate, non-blocking process.

In the context of recovery from a checkpoint, it is on the critical path since training cannot be started without the last checkpoint. The bottleneck is the bandwidth of HDFS, especially when each GPU worker needs to read its corresponding state partition. To alleviate this bottleneck, an optimized data retrieval strategy is provided. Note that multiple GPU workers often share the same state partition, e.g., the workers in the same data parallel group.

Accordingly, a single worker may be designated in the group to read the shared state partition from HDFS, thereby reducing the load linearly. This worker then broadcasts the state partition to all other GPU workers that share the same data. This approach effectively mitigates the bandwidth constraints of HDFS, leading to a substantial reduction in the recovery time.

### Training Troubleshooting

Although our robust training framework automatically discovers, pinpoints, and resolves the majority of common faults, there remain certain hardware anomalies that manifest probabilistically and cannot be found by machine self-checks. Some anomalies may make the system appear to operate normally, yet significantly degrades the training efficiency. To address these nuanced cases, some custom monitoring and analysis tools are designed to support case-by-case anomaly detection.

At the scale of tens of thousands of GPUs, it is observed that, unlike in smaller-scale experiments, different runs exhibit varying computational efficiencies. Even with identical configurations, this inconsistency persists. It is also observed that the performance of training tasks is not consistent at this scale. The MFU for various training tasks gradually declines over time. However, no evident variations are detected under single GPU GEMM micro-benchmarks. To diagnose those performance issues, a performance analysis tool is developed to record the execution time of critical code segments on each machine rank during a run. The tool minimizes the need for Compute Unified Device Architecture (CUDA) synchronization, thus preventing performance degradation, allowing to consistently run the tool in training jobs. This tool offers two visualization modes and can analyze the collected data from different perspectives.

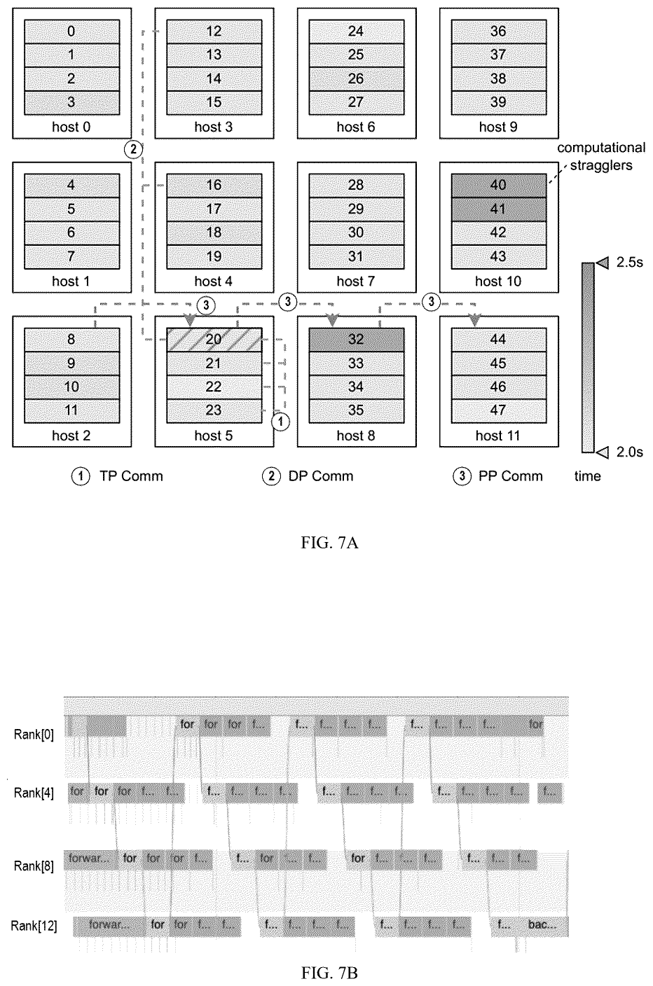

The first mode uses a heat map to show time consumption differences between machines from various dimensions, depicted in FIG. 7A. Latency of the computation phase (forward and backward) across devices may be gathered and averaged across steps. The aggregated data may be visualized using a heat-map. The heat-map reveals that a minor fraction of machines (e.g., approximately 0.5%) exhibit substantially slower performance during training, thereby hindering overall training progress. The training efficiency is predominantly determined by the slowest machine's performance (i.e., stragglers), leading to inconsistencies in training efficiency across diverse runs, since machine scheduling within the cluster is stochastic. After excluding these outlier machines, the peak MFU across runs becomes consistent.

The other mode displays the event timeline on machines in a trace format from different distributed views (data parallelism, pipeline parallelism, tensor parallelism). This approach offers limited insight in distributed training scenarios where execution dependencies frequently span across multiple nodes. By aggregating the trace spans of various ranks onto a singular timeline, a comprehensive perspective is obtained, revealing the overall execution order, pipeline bubbles, and synchronization characteristics among data parallel ranks. FIG. 7B displays how the distributed tracer visualizes the actual execution of pipeline parallelism, detailing the data dependencies between different pipeline stages through the consolidation of event data across a pipeline parallelism group.

Every piece of data from the CUDA event timer is stored in a remote analytical database, allowing for easy retrieval of details from any step event. While the timer data is written to a local file in a line-by-line format, a separate streamer process then synchronizes this log file with a Kafka queue in real-time. The analytical database remains updated by consuming data from this Kafka queue, enabling on-the-fly analysis without interrupting the training job. All the monitoring features are turned on during real production training and the overhead is negligible compared to the training time.

With 3D parallelism and the optimization techniques proposed, the landscape of data flow and task sequencing is exceedingly intricate. Each GPU worker may be engaged in several synchronous or asynchronous operations at the given moment, leading to complex dependencies among them. This intricacy amplifies the challenges of fault diagnosis: when a single GPU worker experiences a fault, the entire cluster of nodes can stall in the NCCL communication operations, ultimately leading to a system-wide timeout. Externally, this situation manifests as a generic blockage, but the root cause of which is often buried under a deluge of timeout messages. To rapidly pinpoint the problematic nodes, each GPU worker may log its own ongoing event upon communication timeout. These logs are then used to construct a visual representation of data dependencies based on the logical topology in the 3D parallel setting.

The cluster in 3D parallel training can logically be split into three dimensions: tensor parallelism, pipeline parallelism, and data parallelism. When a specific GPU worker is selected, the tracer may display its position within the logical topology, the direction of data flow and the different communication operations it involves. Importantly, in the event of an error, the tool provides direct access to the worker's error messages if any. This serves as a powerful tool for diagnosing training anomalies, enabling quicker identification and resolution of faults.

Consider the aforementioned case when defective GPUs probabilistically cause blocking when executing NCCL communication operations. Such blocking can hang the entire machine, leading to cascading timeouts across other dependent nodes and ultimately resulting in the paralysis of the entire training process. To swiftly identify these faulty nodes, the 3D parallel training visualization tool is used. Nodes that timeout due to waiting for the faulty ones will log their ongoing operations upon exiting. In contrast, the nodes with the faulty GPUs are hung and do not log any such information. Therefore, by examining the logs and the data flow within the visualization, these problematic nodes can be easily pinpointed. Once identified, these nodes can be manually isolated and flagged for maintenance through the robust training framework.

### Example Processes

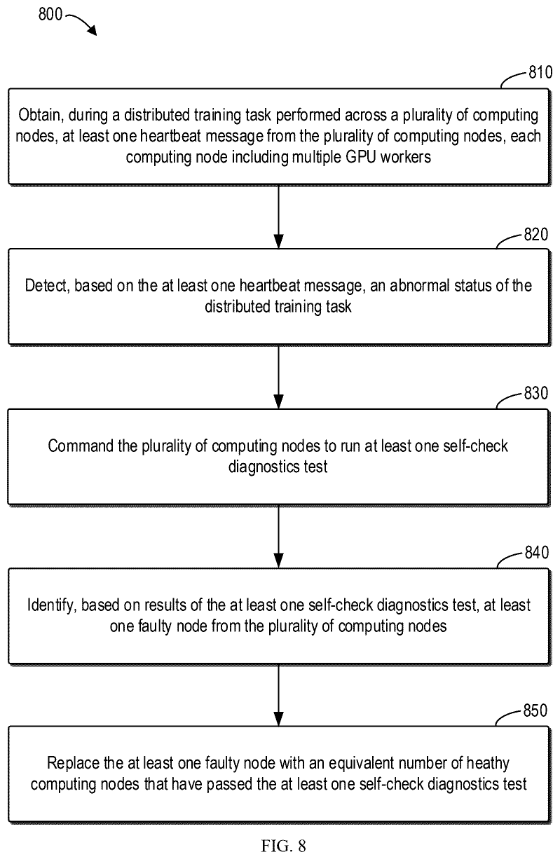

FIG. 8 illustrates a flowchart of an example process for distributed learning according to some embodiments of the present disclosure. The process 800 can be implemented at a device acting as the controller 101 in FIG. 1.

At block 810, the device obtains, during a distributed training task performed across a plurality of computing nodes, at least one heartbeat message from the plurality of computing nodes, each computing node including multiple graphic processing unit (GPU) workers. At block 820, the device detects, based on the at least one heartbeat message, an abnormal status of the distributed training task. At block 830, the device commands the plurality of computing nodes to run at least one self-check diagnostics test. At block 840, the device identifies, based on results of the at least one self-check diagnostics test, at least one faulty node from the plurality of computing nodes. At block 850, the device replaces the at least one faulty node with an equivalent number of heathy computing nodes that have passed the at least one self-check diagnostics test.

In some embodiments, the at least one heartbeat message includes at least one of: output and error logs of a training process running on a corresponding computing node; and a Remote Direct Memory Access (RDMA) traffic metric indicating network utilization and efficiency among the plurality of computing nodes.

In some embodiments, the device may detect the abnormal status of the distributed training task by: performing first monitoring to assess an overall health status and to rule out common configuration impacts on the distributed training task; and performing second monitoring to determine whether there is network congestion among the plurality of computing nodes and whether a data transfer speed of data parallelism and pipe parallelism has reached its physical limit.

In some embodiments, the at least one self-check diagnostics test comprises at least one of: a first test to diagnose potential bottlenecks associated with RDMA network interface cards (RNICs) in an intra-host network of a computing node; or a second test to identify potential faults in GPU communication within a single computing node and among the plurality of computing nodes.

In some embodiments, the device may further suspend, upon detection of the abnormal status of the distributed training task, the distributed training task across the plurality of computing nodes.

In some embodiments, the device may replace the at least one faulty node with an equivalent number of heathy computing nodes that have passed the at least one self-check diagnostics test by: evicting the at least one faulty node from the distributed training task; and loading model weights and optimizer states from the most recent checkpoint into the heathy computing nodes.

In some embodiments, the device may further cause, at a checkpoint, each GPU worker of a computing node to write its on-chip states including the model weights and the optimizer states into a memory of the computing node; and cause the computing node to asynchronously transfer the on-chip states from the memory to a distributed file system.

In some embodiments, the device may load model weights and optimizer states from the most recent checkpoint into the heathy computing nodes by, for a group of GPU workers that share a same state partition of the distributed file system, designating a single GPU worker in the group to read the shared state partition from the distributed file system; and causing the single GPU worker to broadcast the shared state partition to all other GPU works in the group.

In some embodiments, the device may further collect data regarding execution time of a code segment on a set of GPU workers; and identify a computing node, by visualizing the collected data, that includes a GPU worker with slower performance as a faulty node.

In some embodiments, the device may visualize the collected data by generating a heat map that shows time consumption differences time consumption differences between the set of GPU workers.

In some embodiments, the device may visualize the collected data by generating an event timeline on the set of GPU workers in a trace format.

In some embodiments, the device may identify at least one GPU worker with slower performance by displaying a logical topology of the GPU workers with respect to at least one of data parallelism, pipeline parallelism, or tensor parallelism.

### Example System/Device

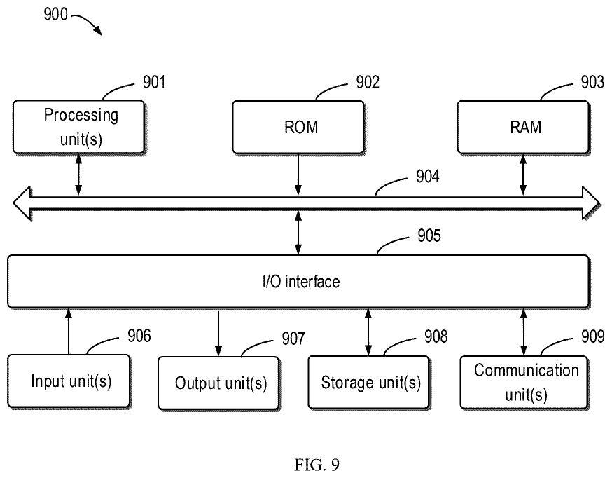

FIG. 9 illustrates a block diagram of an example computing system/device 900 suitable for implementing example embodiments of the present disclosure. The system/device 900 can be implemented as or implemented at the controller 101 of FIG. 1. The system/device 900 may be a general-purpose computer, a physical computing device, or a portable electronic device, or may be practiced in distributed computing environments where tasks are performed by computing nodes that are linked through a communication network. The system/device 600 can be used to implement the process 800 of FIG. 8.

As depicted, the system/device 900 includes a processor 901 which is capable of performing various processes according to a program stored in a read only memory (ROM) 902 or a program loaded from a storage unit 908 to a random access memory (RAM) 903. In the RAM 903, data required when the processor 901 performs the various processes or the like is also stored as required. The processor 901, the ROM 902 and the RAM 903 are connected to one another via a bus 904. An input/output (I/O) interface 905 is also connected to the bus 904.

The processor 901 may be of any type suitable to the local technical network and may include one or more of the following: general purpose computers, special purpose computers, microprocessors, digital signal processors (DSPs), graphic processing unit (GPU), co-processors, and processors based on multicore processor architecture, as non-limiting examples. The system/device 900 may have multiple processors, such as an application-specific integrated circuit chip that is slaved in time to a clock which synchronizes the main processor.

A plurality of components in the system/device 900 are connected to the I/O interface 905, including an input unit 906, such as keyboard, a mouse, or the like; an output unit 907 including a display such as a cathode ray tube (CRT), a liquid crystal display (LCD), or the like, and a loudspeaker or the like; the storage unit 908, such as disk and optical disk, and the like; and a communication unit 909, such as a network card, a modem, a wireless transceiver, or the like. The communication unit 909 allows the system/device 900 to exchange information/data with other devices via a communication network, such as the Internet, various telecommunication networks, and/or the like.

The methods and processes described above, such as the process 800 can also be performed by the processor 901. In some embodiments, the process 800 can be implemented as a computer software program or a computer program product tangibly included in the computer readable medium, e.g., storage unit 908. In some embodiments, the computer program can be partially or fully loaded and/or embodied to the system/device 900 via ROM 902 and/or communication unit 909. The computer program includes computer executable instructions that are executed by the associated processor 901. When the computer program is loaded to RAM 903 and executed by the processor 901, one or more acts of the process 800 described above can be implemented. Alternatively, processor 901 can be configured via any other suitable manners (e.g., by means of firmware) to execute the process 800 in other embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods/processes as described above. Generally, program modules include routines, programs, libraries, objects, classes, components, data structures, or the like that perform particular tasks or implement particular abstract data types. The functionality of the program modules may be combined or split between program modules as desired in various embodiments. Computer-executable instructions for program modules may be executed within a local or distributed device. In a distributed device, program modules may be located in both local and remote storage media.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. The program code may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method comprising:
obtaining, during a distributed training task performed across a plurality of computing nodes, at least one heartbeat message from the plurality of computing nodes, each computing node including multiple graphics processing unit (GPU) workers;
detecting, based on the at least one heartbeat message, an abnormal status of the distributed training task;
commanding the plurality of computing nodes to run at least one self-check diagnostics test;
identifying, based on results of the at least one self-check diagnostics test, at least one faulty node from the plurality of computing nodes; and
replacing the at least one faulty node with an equivalent number of heathy computing nodes that have passed the at least one self-check diagnostics test.

2. The method of claim 1, wherein the at least one heartbeat message includes at least one of:
output and error logs of a training process running on a corresponding computing node; and
a Remote Direct Memory Access (RDMA) traffic metric indicating network utilization and efficiency among the plurality of computing nodes.

3. The method of claim 1, wherein detecting the abnormal status of the distributed training task comprises:
performing first monitoring to assess an overall health status and to rule out common configuration impacts on the distributed training task; and
performing second monitoring to determine whether there is network congestion among the plurality of computing nodes and whether a data transfer speed of data parallelism and pipe parallelism has reached its physical limit.

4. The method of claim 1, wherein the at least one self-check diagnostics test comprises at least one of:
a first test to diagnose potential bottlenecks associated with RDMA network interface cards (RNICs) in an intra-host network of a computing node; or
a second test to identify potential faults in GPU communication within a single computing node and among the plurality of computing nodes.

5. The method of claim 1, further comprising:
suspending, upon detection of the abnormal status of the distributed training task, the distributed training task across the plurality of computing nodes.

6. The method of claim 1, wherein replacing the at least one faulty node with an equivalent number of heathy computing nodes that have passed the at least one self-check diagnostics test comprises:
evicting the at least one faulty node from the distributed training task; and
loading model weights and optimizer states from the most recent checkpoint into the heathy computing nodes.

7. The method of claim 6, further comprising:
at a checkpoint, cause each GPU worker of a computing node to write its on-chip states including the model weights and the optimizer states into a memory of the computing node; and
cause the computing node to asynchronously transfer the on-chip states from the memory to a distributed file system.

8. The method of claim 7, wherein loading model weights and optimizer states from the most recent checkpoint into the heathy computing nodes comprises:
for a group of GPU workers that share a same state partition of the distributed file system,
designating a single GPU worker in the group to read the shared state partition from the distributed file system; and
causing the single GPU worker to broadcast the shared state partition to all other GPU works in the group.

9. The method of claim 1, further comprising:
collecting data regarding execution time of a code segment on a set of GPU workers; and
identifying a computing node, by visualizing the collected data, that includes a GPU worker with slower performance as a faulty node.

10. The method of claim 9, wherein visualizing the collected data comprises:
generating a heat map that shows time consumption differences time consumption differences between the set of GPU workers.

11. The method of claim 9, wherein visualizing the collected data comprises:
generating an event timeline on the set of GPU workers in a trace format.

12. The method of claim 9, wherein identifying at least one GPU worker with slower performance comprises:
displaying a logical topology of the GPU workers with respect to at least one of data parallelism, pipeline parallelism, or tensor parallelism.

13. A device comprising:
at least one processor; and
at least one memory storing instructions that, when executed by the at least one processor, cause the device at least to:
obtain, during a distributed training task performed across a plurality of computing nodes, at least one heartbeat message from the plurality of computing nodes, each computing node including multiple graphics processing unit (GPU) workers;
detect, based on the at least one heartbeat message, an abnormal status of the distributed training task;
command the plurality of computing nodes to run at least one self-check diagnostics test;
identify, based on results of the at least one self-check diagnostics test, at least one faulty node from the plurality of computing nodes; and
replace the at least one faulty node with an equivalent number of heathy computing nodes that have passed the at least one self-check diagnostics test.

14. The device of claim 13, wherein the at least one heartbeat message includes at least one of:
output and error logs of a training process running on a corresponding computing node; and
a Remote Direct Memory Access (RDMA) traffic metric indicating network utilization and efficiency among the plurality of computing nodes.

15. The device of claim 13, wherein, to detect the abnormal status of the distributed training task, the instructions cause the device to:
perform first monitoring to assess an overall health status and to rule out common configuration impacts on the distributed training task; and
perform second monitoring to determine whether there is network congestion among the plurality of computing nodes and whether a data transfer speed of data parallelism and pipe parallelism has reached its physical limit.

16. The device of claim 14, wherein the at least one self-check diagnostics test comprises at least one of:
a first test to diagnose potential bottlenecks associated with RDMA network interface cards (RNICs) in an intra-host network of a computing node; or
a second test to identify potential faults in GPU communication within a single computing node and among the plurality of computing nodes.

17. The device of claim 13, wherein, to replace the at least one faulty node with an equivalent number of heathy computing nodes that have passed the at least one self-check diagnostics test, the instructions cause the device to:
evict the at least one faulty node from the distributed training task; and
load model weights and optimizer states from the most recent checkpoint into the heathy computing nodes.

18. The device of claim 17, wherein the instructions further cause the device to:
at a checkpoint, cause each GPU worker of a computing node to write its on-chip states including the model weights and the optimizer states into a memory of the computing node; and
cause the computing node to asynchronously transfer the on-chip states from the memory to a distributed file system.

19. The method of claim 17, wherein, to load model weights and optimizer states from the most recent checkpoint into the heathy computing nodes, the instructions cause the device to:
for a group of GPU workers that share a same state partition of the distributed file system,
designate a single GPU worker in the group to read the shared state partition from the distributed file system; and
cause the single GPU worker to broadcast the shared state partition to all other GPU works in the group.

20. A non-transitory computer-readable storage medium comprising executable instructions stored therein that, in response to execution by a processor of a device, cause the device to at least:
obtain, during a distributed training task performed across a plurality of computing nodes, at least one heartbeat message from the plurality of computing nodes, each computing node including multiple graphics processing unit (GPU) workers;
detect, based on the at least one heartbeat message, an abnormal status of the distributed training task;
command the plurality of computing nodes to run at least one self-check diagnostics test;
identify, based on results of the at least one self-check diagnostics test, at least one faulty node from the plurality of computing nodes; and
replace the at least one faulty node with an equivalent number of heathy computing nodes that have passed the at least one self-check diagnostics test.
